(19) United States
(12) Patent Application Publication
(10) Pub. No.: US 2006/0030284 A1
(43) Pub. Date: Feb. 9, 2006

(54) Reception control circuit and reception control method

(75) Inventors: Yoshihito Kitayama, Tokyo (JP); Kunio Okada, Iruma-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 11/190,549

(22) Filed: Jul. 27, 2005

(30) Foreign Application Priority Data
Aug. 3, 2004 (JP) 2004-226856
Mar. 15, 2005 (JP) 2005-073106

(51) Int. Cl. H04B 17/02

(52) U.S. Cl. 455/138

(57) ABSTRACT

In order to realize a demodulator circuit and a demodulation method of controlling the amplification degree of an AGC in order that the optimum C/N value near the best C/N value can be always secured in the whole AGC voltage region, the amplification degrees of AGC's 122 and 126 is controlled based on a change of the reception grade of a received signal having been outputted from a FFT 132 of a demodulator circuit unit 13 after being received by an antenna 11 and being amplified by a tuner unit 12. Consequently, the amplification degree can be immediately modified according to a change of the reception grade, and consequently the optimum reception grade can be secured always.

### CROSS-REFERENCE TO RELATED APPLICATIONS

This application is based upon and claims the benefit of priority from the prior Japanese Patent Application No. 2005-73106, filed Mar. 15, 2005, the entire contents of which are incorporated herein by reference.

### BACKGROUND OF THE INVENTION

1. Field of the Invention

The present invention relates to a reception control circuit and a reception control method which are used for receiving or demodulating a signal modulated mainly by digital modulation in a terrestrial broadcast, a CATV broadcast, a satellite broadcast and the like.

2. Description of the Related Art

At present, in a digital television broadcast, a broadcasting satellite (BS) digital broadcast using the BS and a communication satellite (CS) digital broadcast using the CS have become popular. Moreover, a terrestrial digital television broadcast has started its broadcasting from December, 2003, and it is at a transition stage from a terrestrial analog television broadcast to the terrestrial digital television broadcast now. In the terrestrial digital television broadcast, because the orthogonal frequency division multiplexing (OFDM) system is used as its modulation system, a plurality of electric waves (specifically an image, a sound, a data broadcast and the like) are multiplexed to be transmitted.

A reception apparatus receiving a signal of such a digital television broadcast is provided with an automatic gain control circuit (AGC), which adjusts the amplification degree of an amplifier circuit according to the strength of a signal level after a signal amplification by the amplifier circuit in order that a received broadcast wave may be corrected to a stable signal even if the signal level of the broadcast wave has changed.

Moreover, in order to discriminate the degradation of the reception grade caused by the nonlinear distortion and a carrier to noise (C/N) value of an AGC in relation to AGC control, an automatic gain control circuit which detects the reception grade of a signal outputted from a demodulator circuit and performs the AGC control such as changing an amplifier which performs gain control according to a comparison result of the reception grade and a reference level has been also proposed (see, for example, JP-Tokukai-2001-102947A).

FIG. 16 is a graph showing an example of the characteristic of a C/N value to a voltage applied to an AGC (hereinafter referred to as an “AGC voltage”) in order to control an amplification degree. According to the graph, the C/N value once rises with the increase of the AGC voltage. However, when the AGC voltage exceeds X [V], the C/N value falls. The phenomenon is one generated because nonlinear distortion is generated in signal amplification by the AGC and the noises of a carrier wave are amplified. Thus, when the AGC voltage is simply increased in order to increase the C/N value, the C/N value falls from a certain voltage value, and the optimum C/N value cannot be secured to degrade the reception grade.

However, although the invention of JP-Tokukai-2001-102947A describes AGC control in the range in which the C/N value rises with the increase of the AGC voltage (namely, X [V] or less in FIG. 16), the invention does not describe the AGC control in the range in which the AGC voltage exceeds X [V] and the C/N value falls.

When the C/N value of a signal inputted into a demodulation unit falls, it becomes impossible to perform the demodulation processing of the signal correctly, and it also becomes impossible to perform exact error correction processing in an error correction unit. The phenomena lead to the fall of the reception performance and the reliability of a terrestrial digital television broadcast reception apparatus. Accordingly, it is necessary to perform the AGC control in consideration of the changes of the C/N value in the whole AGC voltage region.

The present invention was made in consideration of the above point, and an object of the invention is to realize a reception control circuit and a reception control method of performing the control of the amplification degree of an AGC to always secure the optimum C/N value in the neighborhood of the best C/N value in the whole AGC voltage region.

### SUMMARY OF THE INVENTION

That is, in the reception control circuit or the reception control method according to the present invention, a reception grade of a received signal received in a tuner unit including an amplification unit is detected. Only when the detected reception grade does not satisfy a predetermined reference level, a change of the reception grade is detected based on the reception grade detected by a reception grade detection unit. Then, a control signal for controlling the amplification degree to rise or fall in the amplification unit of the tuner unit is outputted based on the change of the reception grade.

Because of the configuration mentioned above, the amplification degree of an amplification unit is controlled based on a change of the reception grade of a received signal. Consequently, it is possible to modify the amplification degree immediately according to a change of the reception grade, and to always secure the optimum reception grade.

Moreover, in the reception control circuit or the reception control method according to the invention, a reception grade of a received signal received by a tuner unit including a plurality of amplification units is detected. Only when the detected reception grade is detected not to satisfy a predetermined reference level, an amplification degree of at least one of the plurality of amplification units is changed, and a change of the reception grade is detected based on the change of the amplification degree. Then control signals for controlling the respective amplification degrees in the plurality of amplification units of the tuner unit are outputted based on the change of the detected reception grade.

Because of the configuration mentioned above, it is possible to control the plurality of amplification units independently to enable the finer performance of the improvement of the reception grade. Consequently, the optimum reception grade can be always secured.

Furthermore, in the reception control circuit or the reception control method according to the invention, errors of phases and amplitudes of SP signals arranged in a way of being dispersed in a received signal received by a tuner unit including an amplification unit from previously determined phases and previously determined amplitudes, both owned by reference SP signals, are detected as a reception grade. Only when the detected errors are detected not to be zero, a change of the reception grade is detected from the reception grade detected by the reception grade detection unit, and a control signal for controlling an amplification degree of the amplification unit of the tuner unit to rise or fall is outputted based on the detected change of the reception grade.

Owing to having the configuration mentioned above, the amplification degree of the amplification unit is controlled based on the error quantities between the value of predetermined synchronization signals extracted from a received signal and reference values of the synchronization signals as the reception grade. That is, it is possible to immediately adjust the amplification degree according to a change of the reception grade as the error quantities between the values of the predetermined synchronization signals and the reference values of the predetermined synchronization signals, and to always secure the optimum reception grade.

### BRIEF DESCRIPTION OF THE DRAWINGS

FIG. 1 is a block diagram showing the circuit configuration of a terrestrial digital television broadcast reception apparatus according to a first embodiment;

FIG. 2 is a flowchart for illustrating the processing of an AGC voltage calculation unit according to the first embodiment;

FIG. 3 is a view for illustrating the processing of the AGC voltage calculation unit of the first embodiment;

FIG. 4 is a block diagram showing the circuit configuration of a terrestrial digital television broadcast reception apparatus according to a second embodiment;

FIG. 5 is a flowchart for illustrating the processing of an AGC voltage calculation unit of the second embodiment;

FIG. 6 is a view for illustrating the processing of the AGC voltage calculation unit according to the second embodiment;

FIG. 7 is a block diagram showing the circuit configuration of a terrestrial digital television broadcast reception apparatus according to a third embodiment;

FIG. 8 is a view showing an example of an arrangement pattern of SP signals in an OFDM symbol;

FIGS. 9A and 9B are views showing a change of the signal point of an SP signal;

FIG. 10 is a view showing a signal point arrangement of SP signals in the case of a BPSK system;

FIG. 11 is a block diagram showing the circuit configuration of an SP signal error calculation unit;

FIG. 12 is a flowchart for illustrating the processing of an AGC voltage calculation unit of the third embodiment;

FIG. 13 is a view for illustrating processing of the AGC voltage calculation unit according to the third embodiment;

FIG. 14 is a block diagram showing the circuit configuration as a modified example of the third embodiment;

FIG. 15 is a block diagram showing the circuit configuration as a modified example of the first embodiment; and

FIG. 16 is the graph of an AGC voltage-C/N value characteristic.

### DETAILED DESCRIPTION OF THE PREFERRED EMBODIMENTS

In the following, the preferred embodiments of the preset invention are described with illustrated examples. Moreover, although the following descriptions of the embodiments are given to the case where a reception circuit according to the present invention is applied to a terrestrial digital television reception apparatus, it is needless to say that the present invention may be applied to reception apparatuses for receiving terrestrial digital broadcasts such as a BS digital television broadcast, a CS digital television broadcast and a terrestrial digital broadcast by CATV.

### First Embodiment

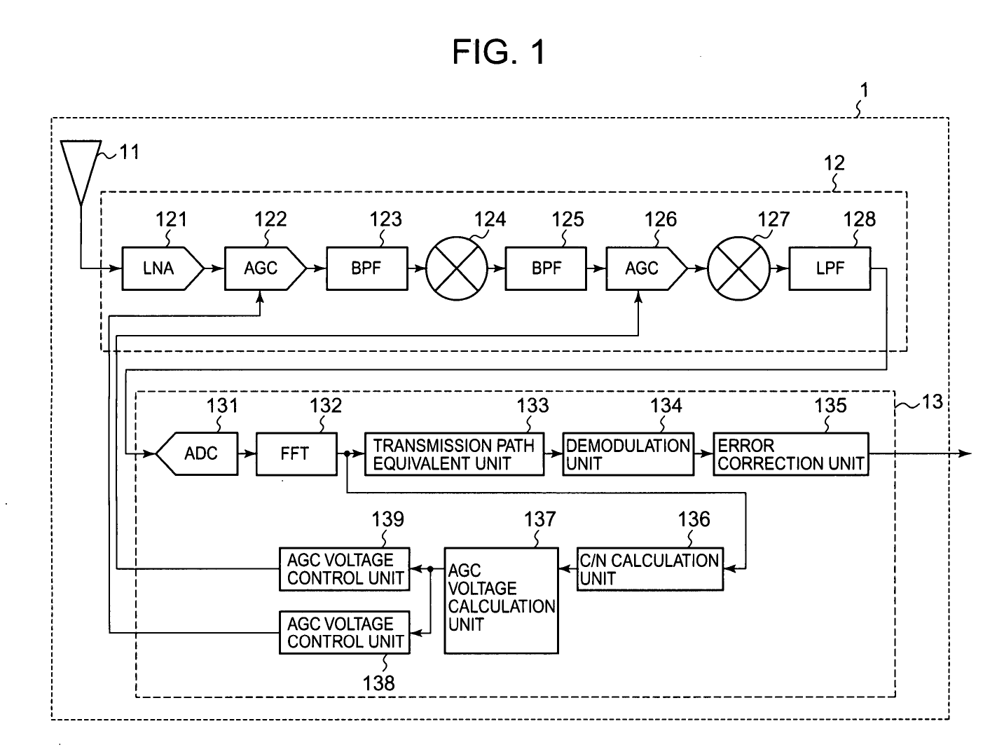

FIG. 1 is the block diagram of a terrestrial digital television broadcast reception apparatus 1. As shown in the block diagram, the terrestrial digital television broadcast reception apparatus 1 is composed of an antenna 11 which receives an electric wave, a tuner unit 12 which amplifies the received electric wave and performs the tuning to a desired broadcast wave frequency, a demodulator circuit unit 13 which mainly performs processing such as digital demodulation and an error correction and outputs a transport stream (TS), and the like.

Furthermore, the tuner unit 12 is composed of a low noise amplifier (LNA) 121, AGC's 122 and 126, band pass filters (BPF's) 123 and 125, an RF mixer 124, an IF mixer 127 and a low pass filter (LPF) 128.

An electric wave received by the antenna 11 is first amplified by the LNA 121 and the AGC 122 by a predetermined amplification degree. The amplification degree of the AGC 122 is made to an appropriate value here by being recursively controlled by a control signal from an AGC voltage control unit 138 according to an output signal level from the BPF 123 and the like.

Only the frequency band having a predetermined width of a signal outputted from the AGC 122 is cut out by the BPF 123, and is converted to an intermediate frequency signal which has a predetermined center frequency by the RF mixer 124 further. Only the frequency band of a predetermined width of the signal outputted from the RF mixer 124 is cut out by the BPF 125, and is amplified by the AGC 126.

Then, the signal outputted from the AGC 126 is converted into a broadcast wave signal having a predetermined center frequency by passing the IF mixer 127 and the LPF 128. The amplification degree of the AGC 126 is recursively controlled to an appropriate value by a control signal from the demodulator circuit 13, which will be described later, according to an output signal level of an ADC 131 and the like.

The demodulator circuit unit 13 is composed of the ADC 131, an FFT 132, a transmission path equivalent unit 133, a demodulation unit 134, an error correction unit 135, a C/N calculation unit 136, an AGC voltage calculation unit 137 and AGC voltage control units 138 and 139.

The signal outputted from the tuner unit 12 is converted into a digital signal from an analog signal by the ADC 131, and the Fourier transformation processing of the digitized signal is performed by the FFT 132. The waveform equivalence (amplitude equivalence and phase equivalence) processing of the signal outputted from the FFT 132 is performed by the transmission path equivalent unit 133, and furthermore the demodulation processing of the processed signal is performed by the demodulation unit 134. The error correction processing is performed to the signal outputted from the demodulation unit 134 by the error correction unit 135, and the processed signal is outputted to the outside of the terrestrial digital television broadcast reception apparatus 1.

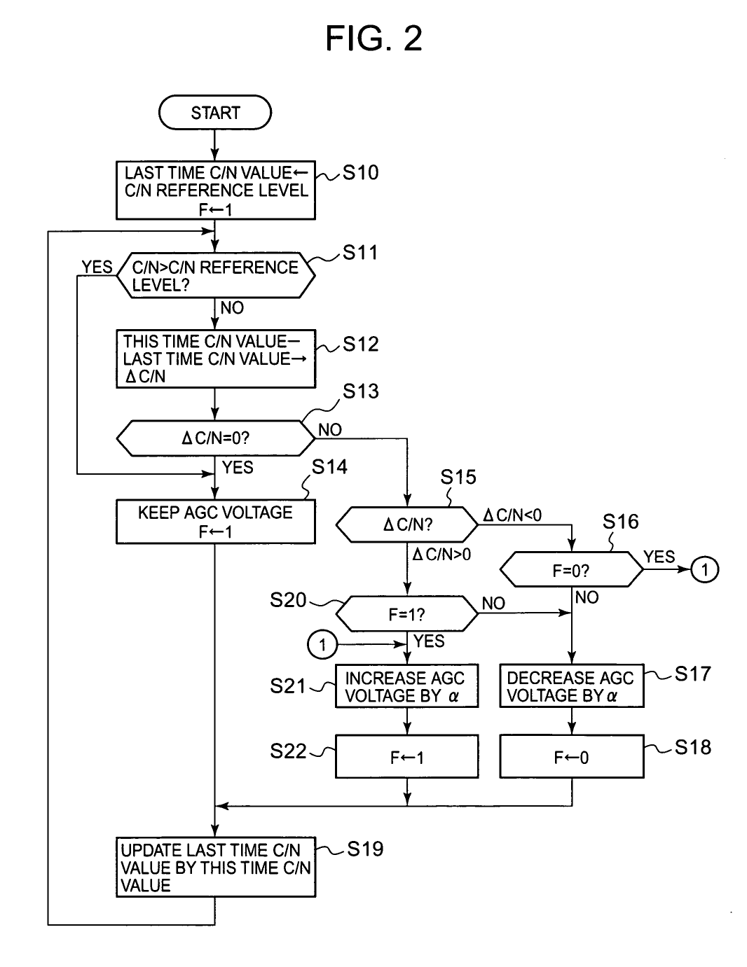

Furthermore, the signal outputted from the FFT 132 is inputted into the C/N calculation unit 136, and the C/N value thereof is calculated as a reception grade of the signal. The AGC voltage calculation unit 137 is a circuit unit of obtaining a change of the C/N value from the C/N value calculated in the C/N calculation unit 136 at this time (hereinafter referred to as a “this time C/N value”) and the C/N value calculated at the last time (hereinafter referred to as a “last time C/N value”), and of determining an increase or decrease value of AGC voltages to the AGC's 122 and 126 based on the change. The AGC voltage calculation unit 137 is composed of a microcomputer, a digital signal processor (DSP) or the like which realizes the circuit operations shown in FIG. 2. The determined increase or decrease value of the AGC voltage is inputted into the AGC voltage control units 138 and 139, and the AGC voltages are determined. Then, the AGC voltage control unit 138 outputs a control signal for controlling the AGC voltage of the AGC 122, and the AGC voltage control unit 139 outputs a control signal for controlling the AGC voltage of the AGC 126.

An example of the control of the AGC's 122 and 126 by the AGC voltage control units 138 and 139, respectively, is described in detail. Although not shown in FIG. 1, the level (effective value) of an output signal from any of the AGC 122, the BPF 123 and the RF mixer 124 is monitored. Then, the AGC's 122 and 126 are configured to perform the following operations. That is, when the monitored value is a predetermined level or less, only the output level of the AGC 122 is controlled by the control signal from the AGC voltage control unit 138. When the level of the output signal of the AGC 122 exceeds the predetermined level after that, only the output level of the AGC 126 is controlled in turn by the control signal from the AGC voltage control unit 139.

The AGC voltage control of the present embodiment is described in detail. FIG. 2 is a flowchart for illustrating the flow of the circuit operation of the AGC voltage calculation unit 137. First, a C/N reference value is stored in a memory (not shown) provided in the AGC voltage calculation unit 137 as a last time C/N value in advance, and a flag F indicating which processing of an increase or a decrease of the AGC voltage is performed is set to “1” (Step S10). Hereupon, the C/N reference level indicates a limit value of the C/N value desired to be maintained. The C/N reference level may be a value set beforehand, or may be suitably changed according to the level of the C/N reference level desired to be secured. Moreover, “F=0” indicates that the processing of decreasing the AGC voltage has been performed, and “F=1” indicates that the processing of increasing the AGC voltage has been performed.

Next, when a C/N value has been calculated and outputted by the C/N calculation unit 136, the AGC voltage calculation unit 137 discriminates whether the this time C/N value is larger than the C/N reference level or not (Step S11). When the reception sensitivity is good and the this time C/N value is larger than the C/N reference level (Step S11; Yes), the AGC voltage calculation unit 137 outputs an instruction signal instructing to make the increase or decrease of the AGC voltage 0, namely to keep the AGC voltage as it is, and sets the flag F to “1” (Step S14). On the other hand, when the reception sensitivity is bad and the this time C/N value is the C/N reference level or less (Step S11; No), the AGC voltage calculation unit 137 subtracts the last time C/N value from the this time C/N value to calculate a changed value ΔC/N of the this time C/N value from the last time C/N value (Step S12).

Then, the AGC voltage calculation unit 137 discriminates whether the changed value ΔC/N is 0 or not (Step S13). When the this time C/N value and the last time C/N value are equal to each other and the changed value ΔC/N is 0 (Step S13; Yes), the AGC voltage calculation unit 137 outputs the instruction signal instructing to make the increase or decrease of the AGC voltage 0, namely to keep the AGC voltage as it is (Step S14).

On the other hand, when the C/N value becomes less than the C/N reference value first, the this time C/N value differs from the last time C/N value, and the changed value ΔC/N becomes not 0 (Step S13; No) but a negative number (Step S15; ΔC/N<0). Then, the processing moves to Step S16. The content of the flag F is judged at Step S16. Because the content in this case is “1”, the processing moves to Step S17, and the AGC voltage calculation unit 137 outputs an instruction signal instructing to decrease the AGC voltage by a predetermined value α. Then, the AGC voltage calculation unit 137 sets the flag F to “0”, which indicates that the instruction signal instructing to decrease the AGC voltage has been outputted (Step 18). Then, the AGC voltage calculation unit 137 updates the last time C/N value by the this time C/N value (Step S19), and repeats the processing operation from Step S11 after this. If the C/N value is improved by having performed the operation of decreasing the AGC voltage, then the changed value ΔC/N becomes a positive value at Step S15 (Step S15; ΔC/N>0), and the processing proceeds to Step S20 to discriminate whether the flag F is “1” or not, namely to discriminate whether the instruction signal instructing to increase the AGC voltage by the predetermined value α has been outputted or not at the last process. In case of this time, the discrimination result is No, and then the processing proceeds to Step S17. Thus, the processing of decreasing the AGC voltage by the predetermined value α is preformed again.

On the other hand, if the C/N value becomes worse by having performed the operation of decreasing the AGC voltage conversely, at Step S15, the changed value ΔC/N becomes a negative value (Step S15; ΔC/N<0), and the processing proceeds to Step S16 to discriminate whether the flag F is “0” or not, namely whether the instruction signal instructing to decrease the AGC voltage by the predetermined value α has been outputted at the last processing or not. Since the flag F is “0” at this time, the progressing proceeds to Step S21, and the AGC voltage calculation unit 137 outputs the instruction signal instructing to increase the AGC voltage by the predetermined value α. After that, the AGC voltage calculation unit 137 sets the flag F to “1”, which indicates that the AGC voltage calculation unit 137 has outputted the instruction signal instructing to increase the AGC voltage (Step S22), and the processing proceeds to Step S19 after that.

As described above, when the C/N value is below the predetermined value, first the AGC voltage is lowered, and the changed state of the C/N value is examined. When the state of the C/N value is improved, the AGC voltage is lowered similarly to the last time. When the state of the C/N value becomes worse, the AGC voltage is raised conversely. In such a way, the control processing of the AGC voltage at the last time is considered while the AGC voltage is controlled at this time. Thereby, even when the C/N value has changed, the AGC voltage can be suitably modified, and high C/N values can be always secured.

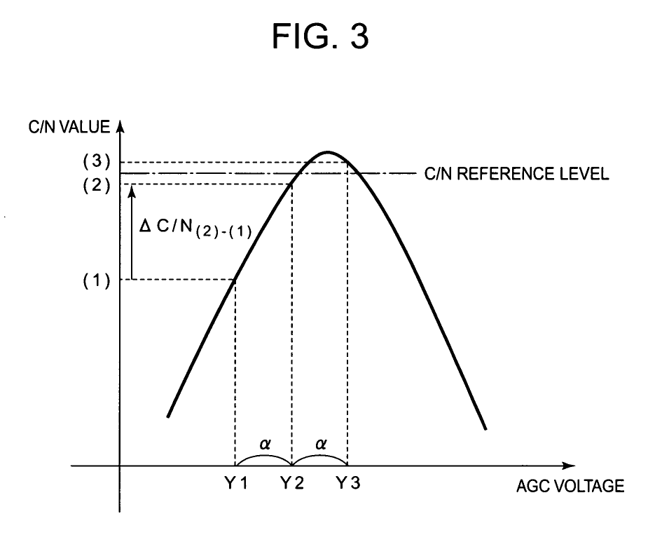

The transition of the C/N value when the AGC voltage is controlled as described above is described using FIG. 3. FIG. 3 is a graph which shows an example of the “AGC voltage-C/N value characteristic.” It is supposed that the last time C/N value when the AGC voltage is Y1 [V] is C/N (1), and that the this time C/N value when the AGC voltage is Y2 [V], which has increased from the AGC voltage Y1 [V] by α, is C/N (2). The changed value from the C/N (2) to the C/N (1) is ΔC/N(2)-(1). In this case, because C/N(1) is smaller than the C/N reference level (Step S11; No), and further because ΔC/N(2)-(1) is not 0 (Step S13; No) but a positive number (Step S15; ΔC/N>0), the C/N is judged to be improved by the increase of the AGC voltage at the last time, and the AGC voltage is further increased by a (Step S21). That is, the AGC voltage becomes Y3 [V] increased from the Y2 [V] by α. Then, the last time C/N value is updated with the C/N (2) (Step S19).

Successively, because the AGC voltage is Y3 [V], the C/N value is calculated to be C/N (3) by the C/N calculation unit 136. When the C/N (3) is supposed to be larger than the C/N reference level (Step S11; Yes), the AGC voltage is maintained to be Y3 [V] (Step S14).

Hereupon, in the AGC voltage-C/N value characteristic shown in FIG. 3, the C/N (3) is the optimum value near the best C/N value in the whole AGC voltage. Because the AGC voltage is controlled in order that the C/N value is always the optimum value in such a way, a high C/N value is always securable. Thereby, the signal outputted from the tuner unit 12 becomes a stable signal with little noises, and consequently demodulation processing is performed accurately. Then, a stable signal is outputted from the terrestrial digital television reception apparatus 1. Therefore, the circuit performance and the reliability of the terrestrial digital television reception apparatus 1 can be improved.

### Second Embodiment

With regard to the first embodiment, the terrestrial digital television broadcast reception apparatus 1 in which the AGC voltage calculation unit 137 outputs the same instruction signals to the AGC voltage control units 138 and 139 has been described. With regard to the second embodiment, a terrestrial digital television broadcast reception apparatus 2 in which the AGC voltage calculation unit outputs an instruction signal to each of a plurality of AGC voltage control units to control them separately is described.

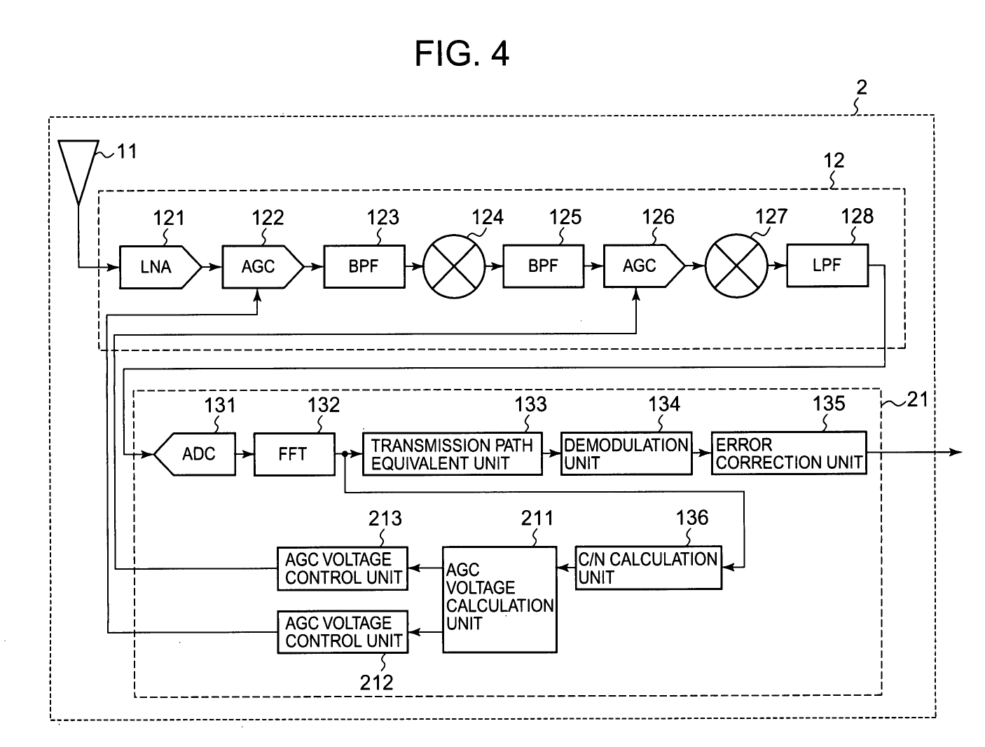

FIG. 4 is a block diagram of the terrestrial digital television broadcast reception apparatus 2. The terrestrial digital television broadcast reception apparatus 2 is configured to be provided with the antenna 11, the tuner unit 12 and the demodulator circuit unit 21. The tuner unit 12 is a circuit unit which performs the processing such as the amplification and the conversion to an intermediate frequency signal to the electric wave received by the antenna 11, and is the same circuit unit as that of the first embodiment.

The demodulator circuit unit 21 is composed of the ADC 131, the FFT 132, the transmission path equivalent unit 133, the demodulation unit 134, the error correction unit 135, the C/N calculation unit 136, an AGC voltage calculation unit 211 and AGC voltage control units 212 and 213.

A signal outputted from the tuner unit 12 is converted into a digital signal from an analog signal by the ADC 131, and the Fourier transformation processing thereof is performed by the FFT 132. The signal outputted from the FFT 132 receives waveform equivalence (amplitude equivalence and phase equivalence) processing by the transmission path equivalent unit 133, and further receives demodulation processing by the demodulation unit 134. The signal outputted from the demodulation unit 134 receives error correction processing by the error correction unit 135, and is outputted to the outside of the terrestrial digital television broadcast reception apparatus 2.

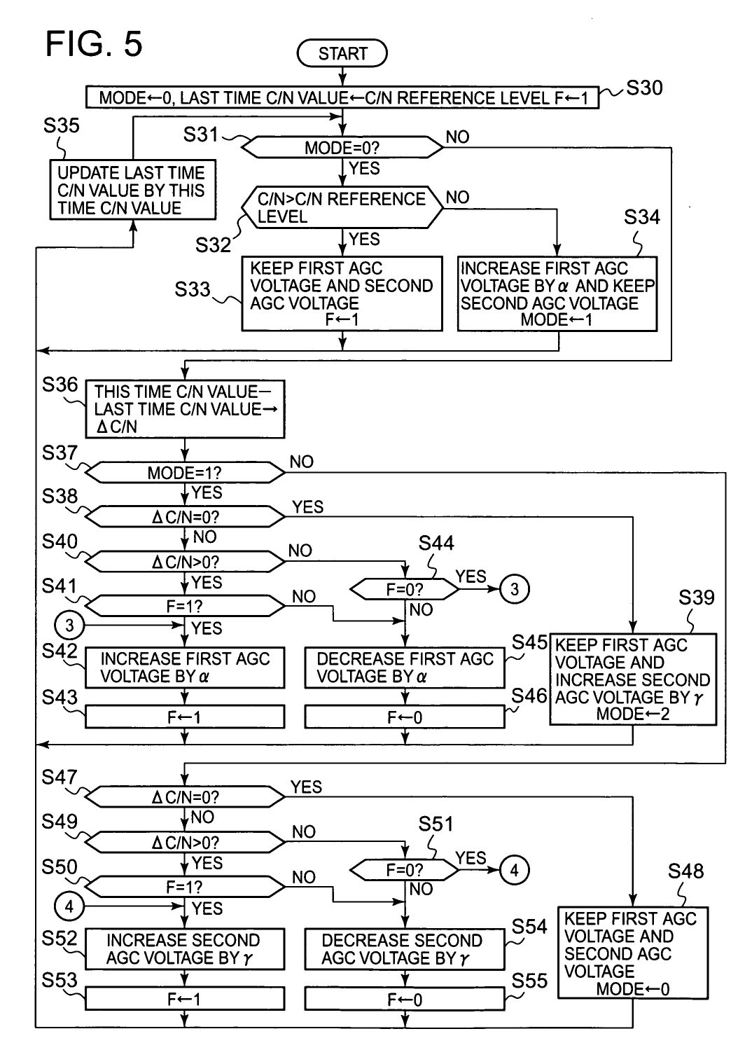

Furthermore, the signal outputted from the FFT 132 is inputted into the C/N calculation unit 136, and a C/N value is calculated as the reception grade of the signal. Then, the AGC voltage calculation unit 211 is a circuit unit obtaining a changed value from the C/N value calculates at the last time (the last time C/N value) to the C/N value calculated at this time (the this time C/N value) to determine increase or decrease values of a first AGC voltage and a second AGC voltage based on the changed value, and is composed of a microcomputer, a DSP or the like realizing the circuit operation shown in FIG. 5. Hereupon, the first AGC voltage is a voltage for performing the amplification degree control of the AGC 122, and the second AGC voltage is a voltage for performing the amplification degree control of the AGC 126.

The increase or decrease value of the first AGC voltage determined by the AGC voltage calculation unit 211 is inputted into the AGC voltage control unit 212, and the first AGC voltage is determined therein. The increase or decrease value of the second AGC voltage is inputted into the AGC voltage control unit 213, and the second AGC voltage is determined therein. Then, the AGC voltage control unit 212 outputs a control signal for controlling the first AGC voltage of the AGC 122, and the AGC voltage control unit 213 outputs a control signal for controlling the second AGC voltage of the AGC 126.

The AGC voltage control of the present embodiment is described more minutely. FIG. 5 is a flowchart for illustrating the flow of the circuit operation of the AGC voltage calculation unit 211. It is supposed that the AGC voltage control is performed in a different way to every mode. First, as the initial values, the followings are set: the variable mode is “0”, the last time C/N value is the C/N reference level, and the flag F indicating the direction of increase or decrease of the last time AGC voltage is “1” (Step S30). Then, the AGC voltage calculation unit 211 discriminates whether the variable mode is “0” or not. When the variable mode is “0” (Step S31; Yes), the AGC voltage calculation unit 211 discriminates whether the this time C/N value is larger than the C/N reference level or not (Step S32). The C/N reference level is a limit value of the C/N value desired to be maintained. The C/N reference level may be a previously set value, or may be suitably changed according to the level of a C/N value desired to be secured.

When the reception sensitivity is good and the this time C/N value is larger than the C/N reference level (Step S32; Yes), the AGC voltage calculation unit 211 outputs an instruction signal instructing the increases or the decreases of the first and the second AGC voltages are 0, namely instructing to keep the first and the second AGC voltages as they are, to each of the AGC voltage control units 212 and 213, and sets the flag F to “1” (Step S33). On the other hand, when the reception sensitivity is bad and the this time C/N value is the C/N reference level or less (Step S32; No), the AGC voltage calculation unit 211 outputs an instruction signal instructing to increase the first AGC voltage by the predetermined value α to the AGC voltage control unit 212, and outputs an instruction signal instructing to keep the second AGC voltage as it is to the AGC voltage control unit 213. Then, the AGC voltage calculation unit 211 sets the variable mode to “1” (Step S34). Successively, the AGC voltage calculation unit 211 updates the last time C/N value by the this time C/N value (Step S35), and repeats the processing from Step S31. The last time C/N value is stored in the memory (not shown) provided in the AGC voltage calculation unit 211.

On the other hand, when the variable mode is not “0” (Step S31; No), the AGC voltage calculation unit 211 calculates a changed value ΔC/N from the C/N value (this time C/N value) outputted from the C/N calculation unit 136 and the C/N value (last time C/N value) outputted last time (Step S36). When the variable mode is “1” (Step S37; Yes), the AGC voltage calculation unit 211 discriminates whether the changed value ΔC/N is 0 or not (Step S38). When the changed value ΔC/N is 0 (Step S38; Yes), the AGC voltage calculation unit 211 outputs an instruction signal instructing to keep the first AGC voltage as it is to the AGC voltage control unit 212, and outputs an instruction signal instructing to increase the second AGC voltage by a predetermined value γ to the AGC voltage control unit 213. Then, the AGC voltage calculating unit 211 sets the variable mode to “2” (Step S39).

On the other hand, when the changed value ΔC/N is not 0 (Step S38; No) and the changed value ΔC/N is a positive number, namely when the C/N is improved (Step S40; Yes), the AGC voltage calculation unit 211 examines the value of the flag F (Step S41). When the flag F is “1”, the AGC voltage calculation unit 211 outputs the instruction signal instructing to increase the first AGC voltage by the predetermined value α to the AGC voltage control unit 212 similarly in the last time, and sets the flag F to “1” (Steps S42 and S43). Moreover, when the flag F is “0”, the AGC voltage calculation unit 211 outputs an instruction signal instructing to decrease the first AGC voltage by the predetermined value α to the AGC voltage control unit 212 similarly in the last time, and sets the flag F to “0” (Steps S45 and S46). On the other hand, when the changed value ΔC/N is a negative value, namely when the C/N becomes worse (Step S40; No), the AGC voltage calculation unit 211 examines the value of the flag F (Step S44). When the flag F is “0”, the AGC voltage calculation unit 211 outputs the instruction signal instructing to increase the first AGC voltage by the predetermined value α to the AGC voltage control unit 212 contrary to the last time, and sets the flag F to “1” (Step S42 and S43). Moreover, when the flag F is not “0”, the AGC voltage calculation unit 211 outputs the instruction signal instructing to decrease the first AGC voltage by the predetermined value α to the AGC voltage control unit 212 also contrary to the last time, and sets the flag F to “0” (Steps S45 and S46). Then, the AGC voltage calculation unit 211 repeats the circuit operation from Step S35.

When the variable mode is “2” (Step 37; No), the AGC voltage calculation unit 211 discriminates whether the changed value ΔC/N is 0 or not (Step S47). Then, when the changed value ΔC/N is 0 (Step S47; Yes), the AGC voltage calculation unit 211 outputs an instruction signal instructing to keep the first and the second AGC voltages as they are to each of the AGC voltage control units 212 and 213. Then, the AGC voltage calculation unit 211 sets the variable mode to “0” (Step S48).

On the other hand, when the changed value ΔC/N is not “0” (Step S47; No) and the change value ΔC/N is a positive value, namely when the C/N is improved (Step S49; Yes), the AGC voltage calculation unit 211 examines the value of the flag F (Step S50). When the flag F is “1”, the AGC voltage calculation unit 211 outputs an instruction signal instructing to increase the second AGC voltage by the predetermined value γ to the AGC voltage control unit 213 similarly in the last time, and sets the flag F to “1” (Steps S52 and S53). Moreover, when the flag F is “0”, the AGC voltage calculation unit 211 outputs an instruction signal instructing to decrease the second AGC voltage by the predetermined value γ to the AGC voltage control unit 213 similarly in the last time, and sets the flag F to “0” (Steps S54 and S55). On the other hand, when the changed value ΔC/N is a negative number, namely the C/N becomes worse (Step S49; No), the AGC voltage calculation unit 211 examines the value of the flag F (Step S51). When the flag F is “0”, the AGC voltage calculation unit 211 outputs the instruction signal instructing to increase the second AGC voltage by the predetermined value γ to the AGC voltage control unit 213 contrary to the last time, and sets the flag F to “1” (Steps S52 and S53). Moreover, when the flag F is not “0”, the AGC voltage calculation unit 211 outputs the instruction signal instructing to decrease the second AGC voltage by the predetermined value γ to the AGC voltage control unit 213 also contrary to the last time, and sets the flag F to “0” (Steps S54 and S55). Then, the AGC voltage calculation unit 211 repeats the circuit operation from Step S35.

By controlling the first and the second AGC voltages according to the changed value of the C/N value and its positiveness or negativeness in such a way, even when the C/N value has changed, the AGC voltage can be modified immediately, and a high C/N value can be always secured.

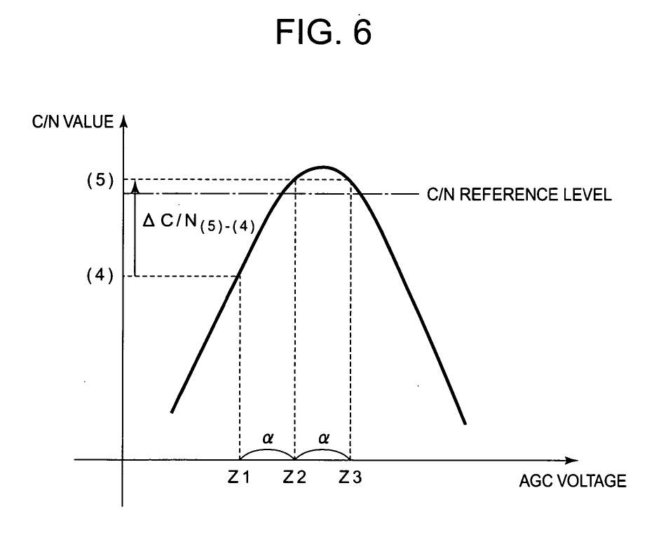

As described above, the transition of the C/N value when the first and the second AGC voltages are controlled is described using FIG. 6. FIG. 6 is a graph showing an example of “the AGC voltage-C/N value characteristic of the AGC 122.” First, it is supposed that the variable mode used for the circuit operation of the AGC voltage calculation unit 211 is set to “0”, and that the first AGC voltage is Z1 [V] and the C/N value is C/N (4). At this time, because the C/N (4) is smaller than the C/N reference level (Step S32; No), the first AGC voltage is increased by the predetermined value α to be Z2 [V]. Then, the variable mode is set to “1” (Step S34). Moreover, C/N (4) is updated as the last time C/N value (Step S35).

Next, because the first AGC voltage is Z2 [V], the C/N value is calculated by the C/N calculation unit 136 to be C/N (5). The changed value from C/N (4) to C/N (5) is ΔC/N(5)-(4) (Step S36). Because the ΔC/N(5)-(4) is not 0 (Step S38; No) but a positive value (Step S40; Yes), the first AGC voltage is increased by the predetermined value α similarly in the last processing (Step S42). That is, the first AGC voltage is increased by the predetermined value α from Z2 [V], and the first AGC voltage is set to Z3 [V]. Then, C/N (5) is updated as the last time C/N value (Step S35).

Successively, because the first AGC voltage is Z3 [V], the C/N value is calculated by the C/N calculation unit 136. When the calculated this time C/N value is the same value as C/N (5), namely when the changed value of the C/N value is 0 (Step S38; Yes), the first AGC voltage is maintained to Z3 [V]. Then, the second AGC voltage is increased by the predetermined value γ, and the variable mode is set to “2” (Step S39). The this time C/N value is updated as the last time C/N value (Step S35), and the second AGC voltage is adjusted in order that the C/N value may become the optimum C/N value after that (Steps S47-S55). By adjusting the second AGC voltage finely, the C/N value can be set to one near to the highest point in the characteristic shown in FIG. 6.

Here, in the “AGC voltage-C/N value characteristic curve” shown in FIG. 6, C/N (5) is the optimum value near the best C/N value in the whole AGC voltage. That is, because the first and the second AGC voltage are controlled in order that the C/N value always becomes the best value, a high C/N value is always securable. Thereby, the signal outputted from the tuner unit 12 becomes a stable signal with little noises, and consequently demodulation processing can be performed accurately. Thus, the stable signal is outputted from the terrestrial digital television reception apparatus 2. Therefore, the circuit performance and the reliability of the terrestrial digital television reception apparatus 2 can be improved.

In the second embodiment described above, although the timing switched to the processing of controlling the second AGC voltage from the processing of controlling the first AGC voltage is determined from the value of ΔC/N (see processing at Steps S38 and S39 of FIG. 5), similarly in the first embodiment, it is also possible to configure the second embodiment to change the processing from that of controlling the first AGC voltage to that of controlling the second AGC voltage by monitoring the level of the output signal from any one of the AGC 122, the BPF 123 and the RF mixer 124, and by detecting whether this level is exceeded or not.

### Third Embodiment

In the first and the second embodiments, the C/N value is used as the reception grade. In a third embodiment, a terrestrial digital television broadcast reception apparatus 3 using the errors of SP signals as reception grade is described.

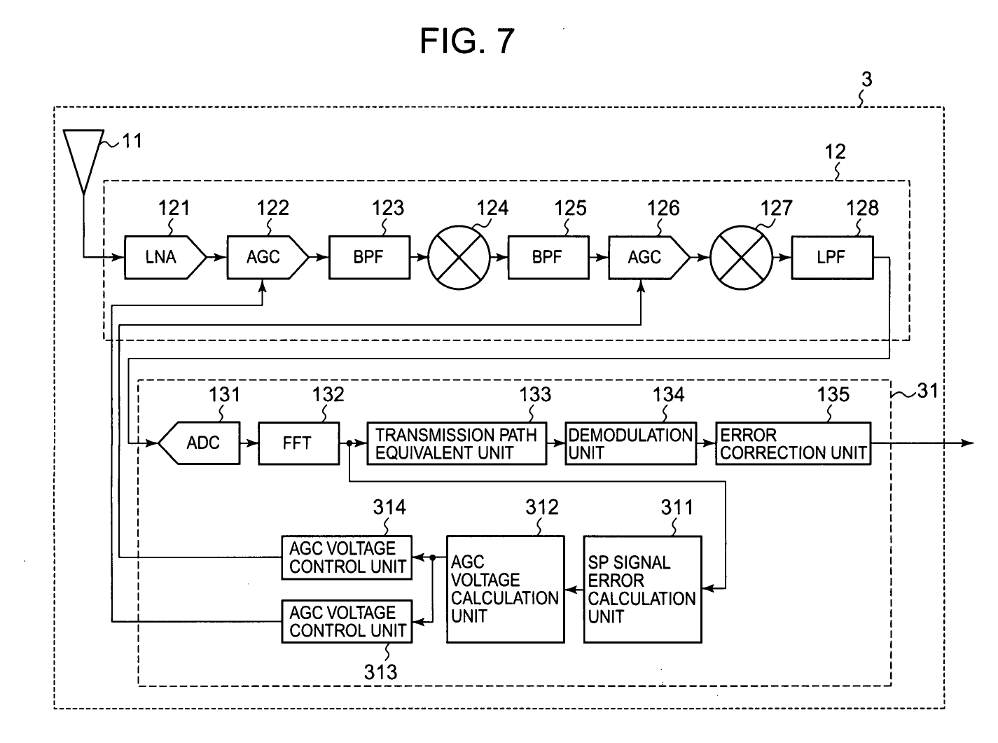

FIG. 7 is a block diagram of the terrestrial digital television broadcast reception apparatus 3. The terrestrial digital television broadcast reception apparatus 3 is configured to be provided with the antenna 11, the tuner unit 12 and a demodulator circuit unit 31. The tuner unit 12 is a circuit unit which performs processing such as an amplification and a conversion to an intermediate frequency signal to an electric wave (received signal) received by the antenna 11, and is the same circuit unit as that of the first embodiment. Moreover, the demodulator circuit unit 31 is composed of the ADC 131, the FFT 132, the transmission path equivalent unit 133, the demodulation unit 134, the error correction unit 135, an SP signal error calculation unit 311, an AGC voltage calculation unit 312 and AGC voltage control units 313 and 314.

A signal outputted from the tuner unit 12 is converted into a digital signal from an analog signal by the ADC 131, and receives Fourier transformation processing by the FFT 132. The signal outputted from the FFT 132 (frequency signal) receives waveform equivalence (amplitude equivalence and phase equivalence) processing by the transmission path equivalent unit 133, and further receives demodulation processing by the demodulation unit 134. The signal outputted from the demodulation unit 134 receives error correction processing by the error correction unit 135, and is outputted to the outside of the terrestrial digital television broadcast reception apparatus 3.

Furthermore, the signal (frequency signal) outputted from the FFT 132 is inputted into the SP signal error calculation unit 311, and “the errors of the SP signals” are calculated as the reception grade of the signal.

The calculation method of the errors of the SP signals by the SP signal error calculation unit 311 is described. The SP signals are a kind of the synchronization signal standardized in the transmission system of the terrestrial digital television broadcast, and are signals used for the waveform equivalence processing by the transmission path equivalent unit 133. Moreover, the SP signals are signals each of which has a predetermined phase and a predetermined amplitude and is arranged to be dispersed in the transmission signal of the terrestrial digital television broadcast.

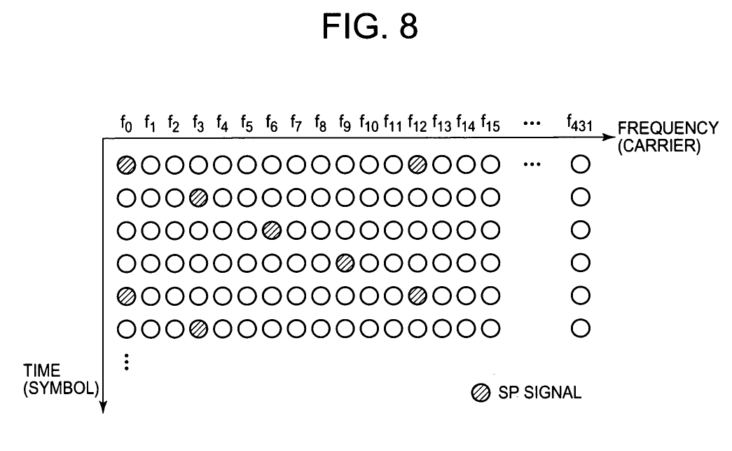

An example of the arrangement pattern of the SP signals in an OFDM symbol is shown in FIG. 8. In the figure, a black dot expresses an SP signal, and a white circle expresses a signal other than the SP signal such as a data signal. Moreover, the figure shows the case where one segment consists of 432 careers (f₀-f₄₃₁), and an SP signal is arranged every 12 careers. That is, 36 SP signals per one symbol are arranged.

The arrangement of the SP signals is determined to change periodically. Therefore, the arrangement positions of the SP signals are uniquely determined by specifying a symbol. In the figure, the arrangement is determined so that four kinds of arrangement patterns may appear in order.

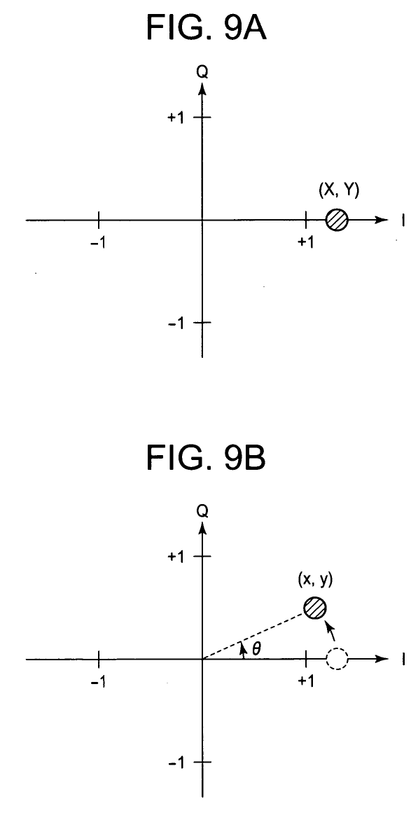

Moreover, the phase and the amplitude of an SP signal change according to the states of a transmission way or the like as the constellation shown in FIGS. 9A and 9B. FIG. 9A shows a signal point arrangement of the original SP signal at the time of transmission (hereinafter referred to as a “reference SP signal”), and FIG. 9B shows a signal point arrangement of the SP signal at the time of reception (hereinafter referred to as a “received SP signal”). The phase of the received SP signal shown in FIG. 9B is changed by “θ” from the phase of the reference SP signal shown in FIG. 9A.

The SP signal error calculation unit 311 calculates a difference between an SP signal (received SP signal) in a frequency signal inputted from the FFT 132 and the predetermined reference SP signal as an “SP signal error.” To put it concretely, in FIGS. 9A and 9B, when the position of the reference SP signal is set to (X, Y) and the position of the received SP signal is set to (x, y), the ratio of the electric power of noises to the carrier power about one SP signal is given by the following formula (1).

$$[ Formula 1 ] \begin{matrix}\frac{{( x - X )}^{2} + {( y - Y )}^{2}}{{X}^{2} + {Y}^{2}} & ( 1 )\end{matrix}$$

Then, as shown in the following formula (2), the average of the power ratio about each SP signal in one symbol is calculated as an “SP signal error.”

$$[ Formula 2 ] \begin{matrix}\frac{1}{N} {\sum }_{i = 1}^{N} \{ \frac{{( {x}_{i} - {X}_{i} )}^{2} + {( {y}_{i} - {Y}_{i} )}^{2}}{{X}_{i}^{2} + {Y}_{i}^{2}} \} & ( 2 )\end{matrix}$$

Incidentally, in the upper formula (2), “N” shows the number of SP signals in one symbol (the number of SP signals).

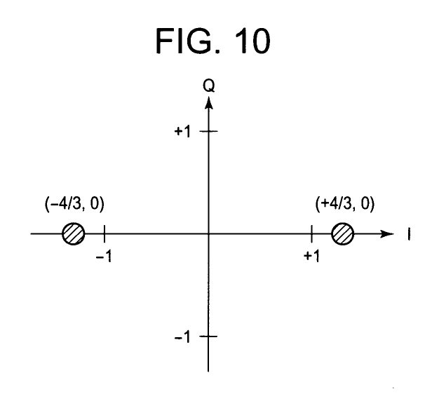

By the way, it is supposed that a binary phase shift keying (BPSK) system is used as the modulation system in the present embodiment. In the case of the BPSK system, as shown in FIG. 10, the positions of the reference SP signal become two kinds of (+4/3, 0) and (−4/3, 0), and their electric power values are equal. That is, in the formula (1), the electric power value of the reference SP signal equivalent to a denominator becomes a fixed value. For this reason, in the present embodiment, the average value of the difference between the each reference SP signal value and each received SP signal value per one symbol, which are given by the following formula (3), is used as the “SP signal error.”

$$[ Formula 3 ] \begin{matrix}\frac{1}{N} {\sum }_{i = 1}^{N} \{ {( {x}_{i} - {X}_{i} )}^{2} + {( {y}_{i} - {Y}_{i} )}^{2} \} & ( 3 )\end{matrix}$$

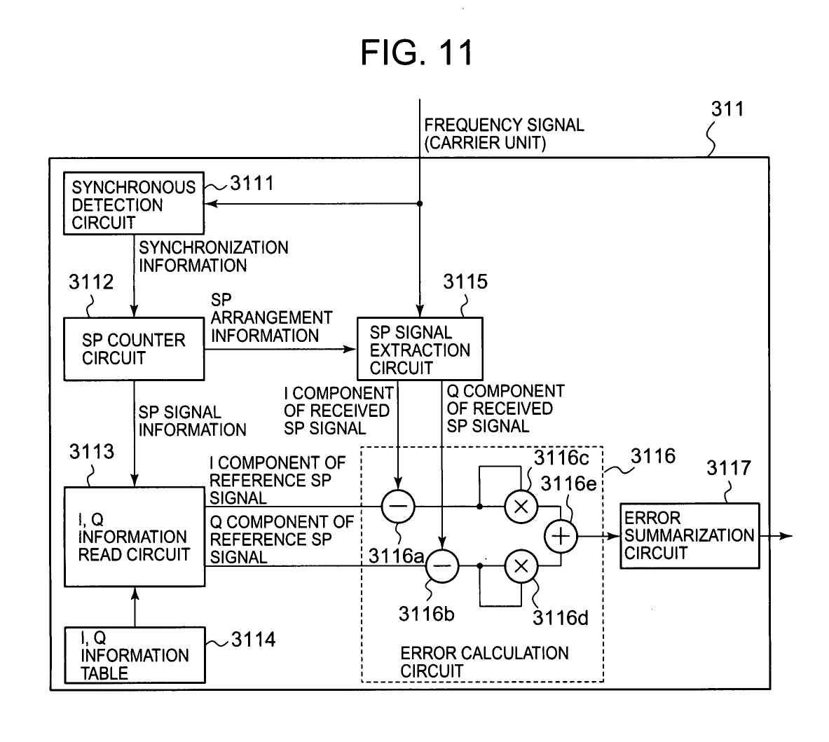

FIG. 11 shows the block diagram of the SP signal error calculation unit 311. As shown in the figure, the SP signal error calculation unit 311 is composed of a synchronous detection circuit 3111, an SP counter circuit 3112, an I, Q information read circuit 3113, an I, Q information table 3114, an SP signal extraction circuit 3115, an error calculation circuit 3116 and an error summarization circuit 3117.

The synchronous detection circuit 3111 generates and outputs synchronization information for synchronizing a received SP signal, being an SP signal in a frequency signal inputted from the FFT 132, with the reference SP signal. To put it concretely, the inputted frequency signal is monitored, and the input of the data of a new symbol is detected. Moreover, the head position of the frame which consists of a plurality of continuous symbols is detected based on the TMCC signal in the frequency signal. Then, information including the information showing that the input of a new symbol has been detected, and the information showing the detection of the head position of a frame are generated as a synchronization signal to be outputted to the SP counter circuit 3112.

The SP counter circuit 3112 generates a count value which specifies a symbol based on the synchronization information inputted from the synchronous detection circuit 3111. That is, if the count value is counted up every reception of a symbol while the frame head position is detected, the count value is updated to an initial value (for example, 0). Then, the symbol received at present is judged from the count value, and SP arrangement information specifying the arrangement pattern related to which carrier the SP signals are arranged in the symbol to be outputted to the SP signal extraction circuit 3115. For example, when the top (the uppermost in the figure) symbol is specified by the count value in FIG. 8, an arrangement pattern expressing that the SP signals are arranged in the carriers of frequencies f₀, f₁₂, f₂₄ . . . is generated and outputted as the SP arrangement information. Moreover, SP signal information specifying which reference SP signal each SP signal expressed by the arrangement pattern is generated and is outputted to the I, Q information read circuit 3113.

I, Q information read circuit 3113 reads and outputs the I, Q component values ((X₁, Y₁) to (X_{N}, Y_{N})) of each reference SP signal specified by the SP signal information inputted from the SP counter circuit 3112 from the I, Q information table 3114.

The I, Q information table 3114 is a data table stored in a memory (not shown) provided in the SP signal error calculation unit 311, and stores the position of each reference SP signal, i.e., I, Q component values (X Y). To put it concretely, in the present embodiment, two kinds of values of (+4/3, 0) and (−4/3, 0) are stored.

The SP signal extraction circuit 3115 extracts and outputs the specified I, Q component values ((x₁, y₁) to (xₙ, yₙ)) of each SP signal (received SP signal) among the frequency signal inputted from the FFT 132 in accordance with the arrangement pattern specified by the SP arrangement information inputted form the SP counter circuit 3112.

The error calculation circuit 3116 includes subtracters 3116a and 3116b, multipliers 3116c and 3116d, and an adder 3116e. A sum of squares of the difference between the received SP signal and the reference SP signal of each signal in each symbol is obtained for every symbol, and the obtained sum of squares is outputted as the SP signal error.

The subtracter 3116a subtracts the I component value X of the reference SP signal inputted from the I, Q information read circuit 3113 from the I component value x of the received SP signal inputted from the SP signal extraction circuit 3115, and outputs the subtraction result. The multiplier 3116c squares the value (x-X) inputted from the subtracter 3116a, and outputs the squared value.

The subtracter 3116b subtracts the Q component value Y of the reference SP signal inputted from the I, Q information read circuit 3113 from the Q component value y of the received SP signal inputted from the SP signal extraction circuit 3115, and outputs the subtraction result. The multiplier 3116d squares the value (y-Y) inputted from the subtracter 3116b, and outputs the squared value.

Then, the adder 3116e adds the value (x-X)² outputted from the multiplier 3116c and the value (y-Y)² outputted from the multiplier 3116d, and outputs the addition result.

Then, the error summarization circuit 3117 adds all of the values outputted from the error calculation circuit 3116, and divides the added value by the number N of the SP signals per symbol to calculate the SP signal error per symbol. The value outputted from the error summarization circuit 3117 is the “SP signal error” per symbol which the SP signal error calculation circuit 3116 calculates.

Then, the AGC voltage calculation unit 312 determines the AGC voltage of each of the AGC's 122 and 126 based on the “SP signal error” calculated by the SP signal error calculation unit 311. To put it concretely, the AGC voltage calculation unit 312 obtains a changed value from the SP signal error calculated at the last time (hereinafter referred to as “the last time error”) to the SP signal error calculated this time (hereinafter referred to as a “this time error”), and determines the increase or decrease value of the first and the second AGC voltages based on the obtained changed value. Here, the first AGC voltage is a voltage for performing the amplification degree control of the AGC 122, and the second AGC voltage is a voltage for performing the amplification degree adjustment of the AGC 126.

The increase or decrease value of the first AGC voltage determined by the AGC voltage calculation unit 312 is inputted into the AGC voltage control unit 313, and the first AGC voltage is determined. The increase or decrease value of the second AGC voltage is inputted into the AGC voltage control unit 314, and the second AGC voltage is determined. Then, the AGC voltage control unit 313 outputs a control signal for controlling the first AGC voltage of the AGC 122, and the AGC voltage control unit 314 outputs a control signal for controlling the second AGC voltage of the AGC 126.

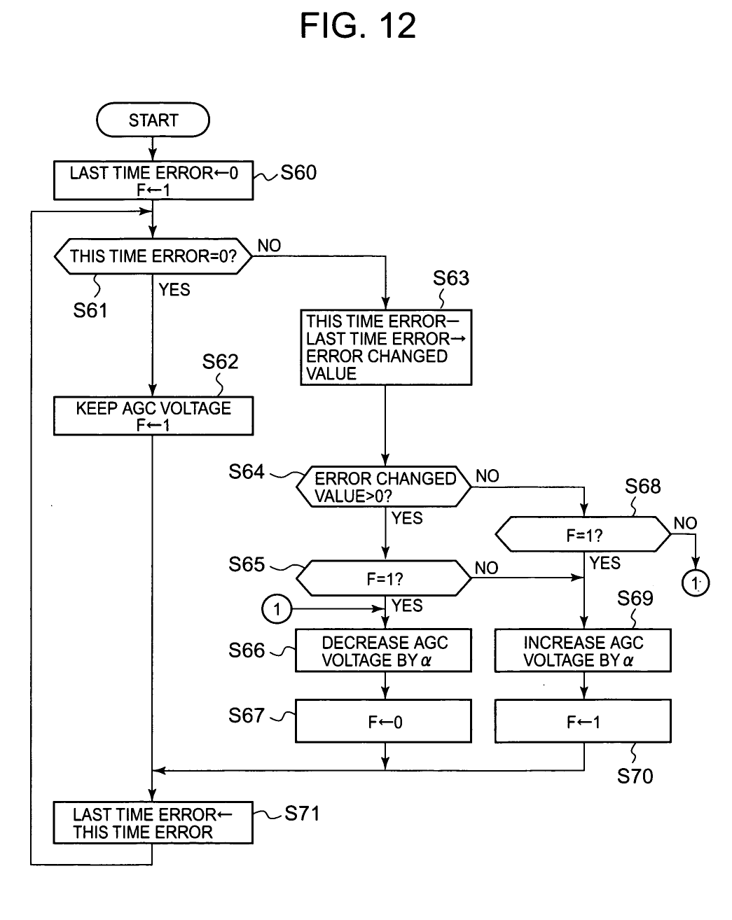

The AGC voltage control of the present embodiment is further described in detail. FIG. 12 is a flowchart for illustrating the flow of the circuit operation of the AGC voltage calculation unit 312. First, the AGC voltage calculation unit 312 stores “0” in the memory (not shown) provided in the AGC voltage calculation unit 312 as the last time error, and sets the flag F indicating having performed the processing of an increase or a decrease of the AGC voltage to “1” (Step S60).

Next, when the SP signal error is calculated by the SP signal error calculation unit 311 and the calculation result is outputted, the AGC voltage calculation unit 312 judges whether the inputted value, namely the this time error, is “0” or not. When the this time error is “0” (Step S61; Yes), the AGC voltage calculation unit 312 outputs an instruction signal instructing to set the increase or decrease of the AGC voltage to “0”, namely to keep the AGC voltage as it is, and sets the flag F to “1” (Step S62).

On the other hand, when the tins time error is not “0” (Step S61; No), the AGC voltage calculation unit 312 calculates an error changed value by subtracting the last time error from the this time error (Step S63), and judges whether the error changed value is larger than “0” or not.

When the error changed value is larger than “0” (Step S64: Yes), the AGC voltage calculation unit 312 judges the value of the flag F. When the value of the flag F is “1”, which indicates that an instruction signal instructing to increase the AGC voltage has been issued at the last time, the AGC voltage calculation unit 312 outputs an instruction signal instructing to decease the AGC voltage by the predetermined value α (Step S66). Then, the AGC voltage calculation unit 312 sets the flag F to “0”, which indicates that an instruction signal instructing to decrease the AGC voltage has been issued (Step S67), and the processing proceeds to Step S71 after that.

Moreover, when the value of the flag F is not “1”, namely when it is “0”, which indicates that the instruction signal instructing to decrease the AGC voltage last time has been issued, (Step S65; No), the AGC voltage calculation unit 312 outputs an instruction signal to increase the AGC voltage by a predetermined value (Step S69). Then, the AGC voltage calculation unit 312 sets the flag F to “1”, which indicates that the instruction signal instructing to increase the AGC voltage has been issued, and then the processing proceeds to Step S71 after that.

On the other hand, when the error changed value is not larger than “0”, namely it is smaller than “0” (Step S64; No), the AGC voltage calculation unit 312 judges the value of the flag F. When the value of the flag F is “1” (Step S68; Yes), the AGC voltage calculation unit 312 outputs an instruction signal instructing to increase the AGC voltage by the predetermined α (Step S69), and sets the flag F to “1”. The processing proceeds to Step S71 after that. On the other hand, when the flag F is not “1”, namely when the flag F is “0” (Step S68; No), the AGC voltage calculation unit 312 outputs an instruction signal instructing to decrease the AGC voltage by the predetermined α (Step S66), and sets the flag F to “0” (Step S67). After that, the processing proceeds to Step S71.

Then, at Step S71, the AGC voltage calculation unit 312 updates the this time error as the last time error (Step S71), and the processing of the AGC voltage calculation unit 312 returns to Step S61 after that.

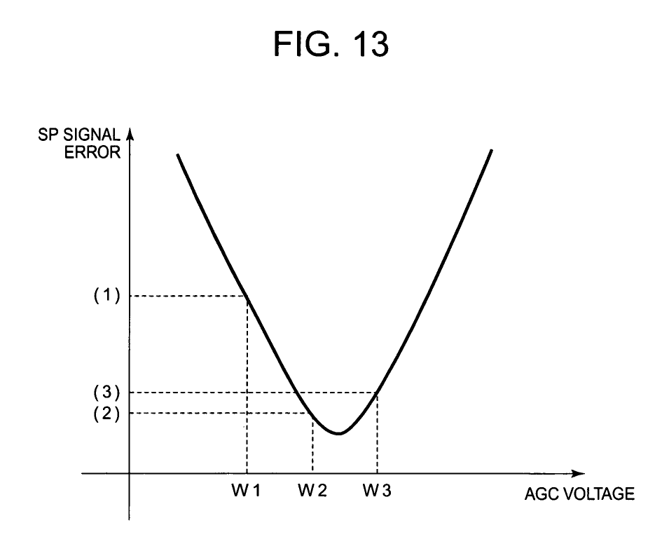

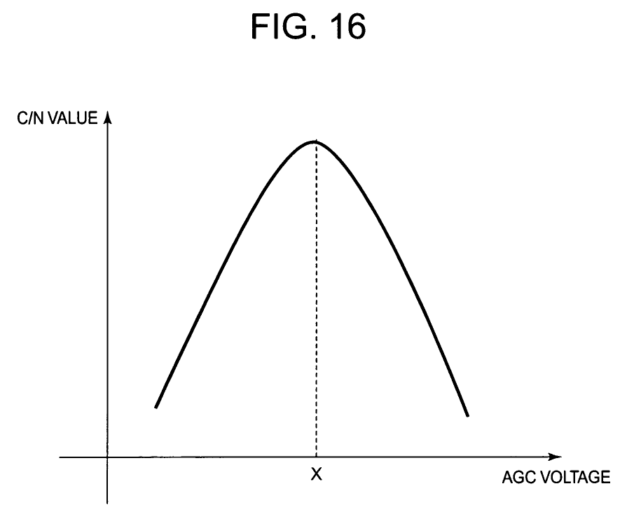

The transition of the C/N value when the AGC voltage control has been performed in the way described above is described with reference to FIG. 13. The figure is a graph showing an example of the “AGC voltage-SP signal error” characteristic. By the way, there is a relation an example of which is shown in FIG. 16 as the characteristic of the C/N value to the AGC voltage. Moreover, there is a reverse relation between the C/N value and the SP signal error to the reception grade. That is, the increase of the C/N value expresses the improvement of the reception grade, and the decrease of the C/N value expresses the degradation of the reception grade. On the other hand, the increase of the SP signal error expresses the increase of noises, namely the degradation of the reception grade, and the decrease of the SP signal error expresses the decrease of the noises, namely the improvement of the reception grade. Consequently, there is the relation between the C/N value and the SP signal: when the. C/N value becomes larger, the SP signal error becomes smaller; and conversely when the C/N value decreases, the SP signal error becomes larger. For this reason, the characteristic of the SP signal error to the AGC voltage becomes the graph shown in FIG. 13, for example.

In FIG. 13, it is supposed that the SP signal error is an error (1) when the AGC voltage is W1 [V], and that the SP signal error is error (2) when the AGC voltage is W2 [V]. Then, when the AGC voltage is increased from W1 [V] to W2 [V] by α, because the error (2), which is the this time error, is smaller than the error (1), which is the last time error, (error (2)<error (1)), the error changed value becomes a negative value (Step S64; No), and the flag F is “1”, which indicates that the AGC voltage has been increased (Step S68; Yes). Consequently, it is judged that the error became smaller, namely, it is judged that the C/N value has been improved, and then the AGC voltage is further increased by α to be W3 [V] (Step S69). Then, the error (2) is set as the last time error (Step S71).

When the AGC voltage becomes W3 [V], the this time error is made to an error (3), and the error (3) is larger than the last time error (2) (error (3)>error (2)), the error changed value becomes a positive value (Step S64; Yes). Moreover, because the flag F is “1” (Step S65; Yes), it is judged that the error has increased, namely the C/N value has fallen, and the AGC voltage is decreased by a (Step S66). Then, the error (3) is set as the last time error (Step S71).

In such a way, the AGC voltage is controlled in order that the SP signal error may become the smallest, namely in order that the C/N value may become the highest (the best) value. Consequently, an always high C/N value is secured. Thereby, the signal outputted from the demodulator circuit unit 31 becomes a stable signal with little noises, and consequently the demodulation processing is performed accurately. Moreover, a stable signal is outputted from the terrestrial digital television broadcast reception apparatus 3. Therefore, the circuit performance and the reliability of the terrestrial digital television broadcast reception apparatus 3 can be improved.

In addition, in the third embodiment, although the SP signal error, which is a kind of a synchronization signal, is used as the reception grade, even if other synchronization signals such as a CP signal are used, the reception grade is realizable similarly.

Moreover, although the average value of the difference between the reference SP signal and the received SP signal is used as the “SP signal error” to all of the SP signals in one symbol, (1) in stead of all of the SP signals, some of them (for example, the careers near the center of the symbol and the careers of the latter half portion, and the like) may be used; (2) an average value about several symbols in the past including the present symbol may be used; and (3) in stead of the average value, the total of the difference about each SP signal may be used.

Moreover, as an modulation system, although the case of a BPSK system has been described, similarly other modulation systems such as a quadrature phase shift keying (QPSK) system, a 16-quadrature amplitude modulation (QAM) system and a 64-QAM system may be applicable. However, in this case, because the electric power value of each reference SP signal is not constant, the SP signal error is calculated in accordance with the formula (2).

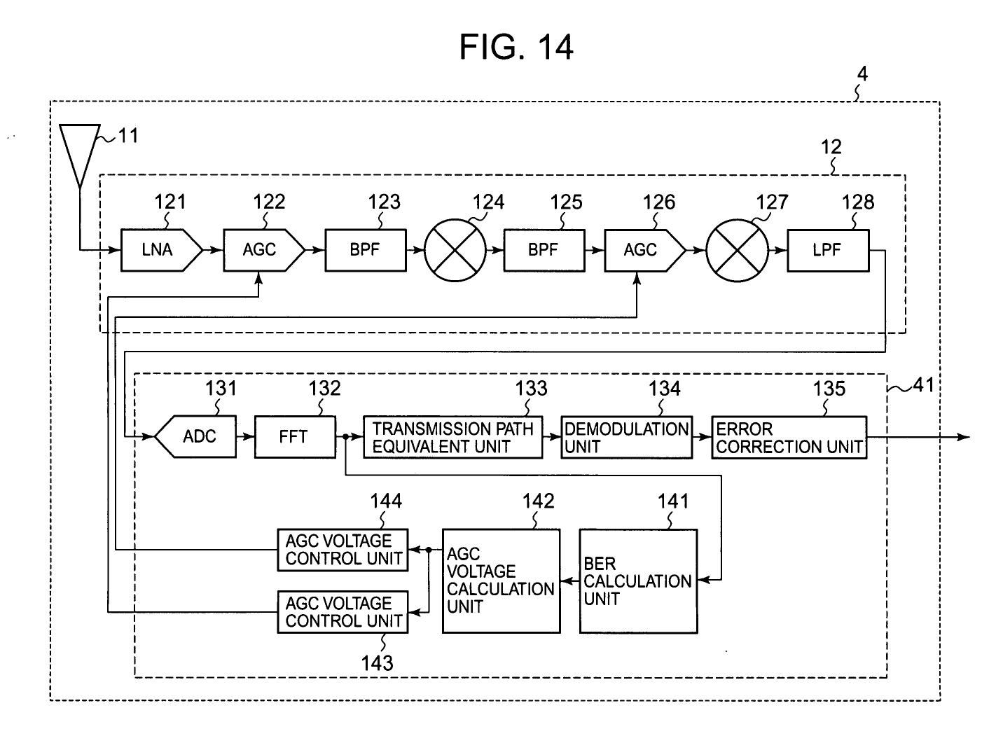

Moreover, although the C/N value is used as the reception grade in the first and the second embodiments described above and the SP signal error is used as the reception grade in the third embodiment described above, a bit error rate (BER) may be used as another reception grade. The block diagram of a terrestrial digital television broadcast reception apparatus 4 using the BER as the reception grade is shown in FIG. 14 as a modified example of the third embodiment. Incidentally, in this figure, the same reference marks are attached to the same configuration elements as those of each embodiment described above (see FIGS. 1, 4 and 7).

According to FIG. 14, a terrestrial digital television broadcast reception apparatus 4 is configured to be provided with the antenna 11, the tuner unit 12 and a demodulator circuit unit 41. The demodulator circuit unit 41 is composed of the ADC 131, the FFT 132, the transmission path equivalent unit 133, the demodulation unit 134, the error correction unit 135, a BER calculation unit 141, an AGC voltage calculation unit 142, and AGC voltage control units 143 and 144.

The BER calculation unit 141 calculates a BER as the reception grade of a signal (frequency signal) inputted from the FFT 132.

The AGC voltage calculation unit 142 determines the increase or decrease values of the first AGC voltage and the second AGC voltage based on the BER calculated by the BER calculation unit 141 similarly in the AGC voltage calculation unit 136 of the first embodiment described above. That is, the AGC voltage calculation unit 142 obtains a changed value from the BER (last time BER) calculated by the BER calculation unit 141 at the last time to the BER (this time BER) calculated at this time, and determines the increase or decrease values of the first AGC voltage and the second AGC voltage based on the changed value.

Then, the AGC voltage control unit 143 outputs a control signal for controlling the amplification degree of the first AGC voltage of the AGC 122 based on the increase or decrease value of the first AGC voltage determined by the AGC voltage calculation unit 142, and the AGC voltage control unit 144 outputs a control signal for controlling the amplification degree of the second AGC voltage of the AGC 126 based on the increase or decrease value of the second AGC voltage determined by the AGC voltage calculation unit 142.

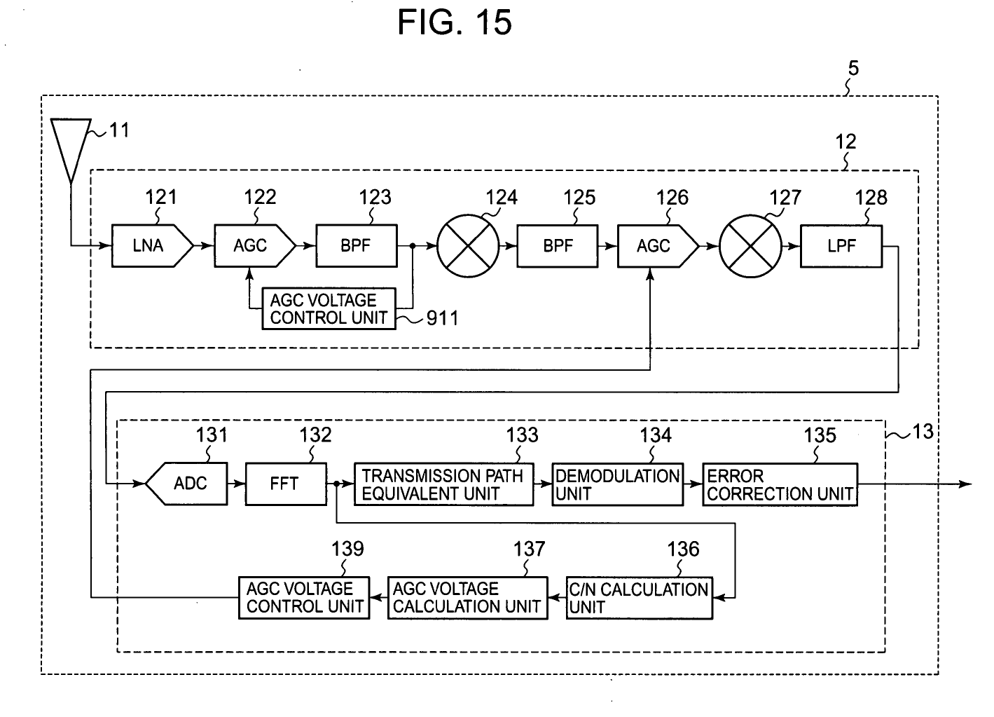

Moreover, although the AGC voltage calculation unit 137 determines the increase or decrease values of the AGC voltages to the AGC's 122 and 126 based on the change C/N value calculated by the C/N calculation unit 136 in the first embodiment described above, as shown in FIG. 15, the AGC voltage calculation unit 137 may determine the increase or decrease value of the AGC voltage to the AGC 126 on one side, and may output the determined voltage to the AGC voltage control unit 139, which outputs the control signal for controlling the AGC voltage of the AGC 126. In this case, the AGC 122 is recursively controlled by the control signal from an AGC control unit 911 according to the level of the output signal from the BPF 123 or the like. The block diagram of the terrestrial digital television broadcast reception apparatus 5 as a modified example of the first embodiment described above is shown in FIG. 15.

Furthermore, similarly as for the third embodiment, the AGC voltage calculation unit 312 is configured to determine the increase or decrease values of the AGC voltages to the AGC's 122 and 126 based on the change of the SP signal error calculated by the SP signal error calculation unit 311, but, although it is not shown, the AGC voltage calculation unit 312 may determine the increase or decrease value of the AGC voltage to the AGC 126 on one side, and may output the determined voltage to the AGC voltage control unit 314. In this case, the AGC 122 is recursively controlled by the control signal from the AGC control unit 911 according to the level of the output signal from the BPF 123 or the like.

What is claimed is:

1. A reception control circuit, comprising:
a reception grade detection unit for detecting a reception grade of a received signal received by a tuner unit including an amplification unit;
a reference level detection unit for detecting whether the reception grade detected by the reception grade detection unit satisfies a predetermined reference level;
a change detection unit for detecting a change of the reception grade based on the reception grade detected by the reception grade detection unit only when the reception grade is detected not to satisfy the reference level by the reference level detection unit; and
a control signal output unit for outputting a control signal for controlling an amplification degree of an amplification unit of the tuner unit to raise or lower the amplification degree based on the change of the reception grade detected by the change detection unit.

2. The reception control circuit as claimed in claim 1, wherein the change detection unit includes a difference operation unit for obtaining a difference between a reception grade detected at this time and a reception grade detected at a last time; a discrimination unit for discriminating existence of the change of the reception grade by discriminating whether the obtained difference is zero or not; a storage unit for storing the reception grade detected at this time as the reception grade detected at the last time after discrimination has been performed by the discrimination unit.

3. The reception control circuit as claimed in claim 2, wherein the control signal output unit does not change the amplification degree when the discrimination unit has discriminated that there is no change of the reception grade.

4. The reception control circuit as claimed in claim 2, wherein the control signal output unit includes a positive/negative judgment unit for judging positiveness and negativeness of the difference obtained by the difference operation unit when the discrimination unit has discriminated that there is a change of the reception grade; and an amplification degree control unit for performing control of the amplification degree based on a judgment result of the positiveness and negativeness judgment unit and a state of the control signal outputted in detection of the change at the last time.

5. The reception control circuit as claimed in claim 4, wherein the amplification degree control unit raises the amplification degree when the difference obtained by the difference operation unit is positive and the control signal outputted in detection of the change at the last time is in a state of permitting a rising control, and when the difference obtained by the difference operation unit is negative and the control signal outputted in detection of the change at the last time is in a state of permitting a lowering control, and lowers the amplification degree when the difference obtained by the difference operation unit is negative and the control signal outputted in detection of the change at the last time is in the state of permitting the rising control, and when the difference obtained by the difference operation unit is positive and the control signal outputted in detection of the change at the last time is in the state of permitting lowering control.

6. The reception control circuit as claimed in claim 5, wherein the amplification degree control unit makes the control signal in a state of performing the rising control when the amplification degree has been raised, and makes the control signal in a state of performing the lowering control when the amplification degree has been lowered.

7. The reception control circuit as claimed in claim 1, wherein the reception grade detection unit detects a C/N value of the received signal.

8. The reception control circuit as claimed in claim 1, wherein the reception grade detection unit detects a BER value of the received signal.

9. A reception control circuit, comprising:
a reception grade detection unit for detecting a reception grade of a received signal received by a tuner unit including a plurality of amplification units;
a reference level detection unit for detecting whether the reception grade detected by the reception grade detection unit satisfies a predetermined reference level or not;
an amplification degree change unit for changing at least one of amplification degrees of the plurality of amplification units only when the reception grade does not satisfy the reference level, which is detected by the reference level detection unit;
a change detection unit for detecting a change of the reception grade detected by the reception grade detection unit based on a change of the amplification degree by the amplification degree change unit; and
a control signal output unit for outputting a control signal for controlling an amplification degree of each of the plurality of amplification units of the tuner unit based on the change of the reception grade detected by the change detection unit.

10. The reception control circuit as claimed in claim 9, wherein the change detection unit includes a difference operation unit for obtaining a difference between a reception grade detected at this time and a reception grade detected at a last time; a discrimination unit for discriminating existence of the change of the reception grade by discriminating whether the obtained difference is zero or not; a storage unit for storing the reception grade detected at this time as the reception grade detected at the last time after discrimination has been performed by the discrimination unit.

11. The reception control circuit as claimed in claim 10, wherein the control signal output unit controls the amplification degree change unit in order to change an amplification degree of another amplification unit of the tuner unit when the discrimination unit has discriminated that there is no change of the reception grade.

12. The reception control circuit as claimed in claim 10, wherein the control signal output unit includes a positive/negative judgment unit for judging positiveness and negativeness of the difference obtained by the difference operation unit when the discrimination unit has discriminated that there is a change of the reception grade; and an amplification degree control unit for performing control of the amplification degree of the amplification unit changing the amplification degree in the amplification degree unit based on a judgment result of the positiveness and negativeness judgment unit and a state of the control signal outputted at the last detection of the change.

13. The reception control circuit as claimed in claim 12, wherein the amplification degree control unit raises the amplification degree when the difference obtained by the difference operation unit is positive and the control signal outputted in detection of the change at the last time is in a state of permitting a rising control, and when the difference obtained by the difference operation unit is negative and the control signal outputted in detection of the change at the last time is in a state of permitting a lowering control, and lowers the amplification degree when the difference obtained by the difference operation unit is negative and the control signal outputted in detection of the change at the last time is in the state of permitting the rising control, and when the difference obtained by the difference operation unit is positive and the control signal outputted in detection of the change at the last time is in the state of permitting lowering control.

14. The reception control circuit as claimed in claim 13, wherein the amplification degree control unit makes the control signal in a state of performing the rising control when the amplification degree has been raised, and makes the control signal in a state of performing the lowering control when the amplification degree has been lowered.

15. The reception control circuit as claimed in claim 9, wherein the reception grade detection unit detects a C/N value of the received signal.

16. A reception control circuit, comprising:
a reception grade detection unit for detecting an error of phases and amplitudes owned by SP signals arranged in a received signal in a way of being dispersed therein, the received signal received by a tuner unit including an amplification unit, from phases and amplitudes having been previously determined, the previously determined phases and the previously determined amplitudes owned by a reference SP signal, as a reception grade;
an error detection unit for detecting whether the error detected by the reception grade detection unit is zero or not;
a change detection unit for detecting a change of the reception grade detected by the reception grade detection unit only when the error is detected not to be zero by the error detection unit; and
a control signal output unit for outputting a control signal for controlling an amplification degree of the amplification unit of the tuner unit to raise or lower the amplification degree based on the change of the reception grade detected by the change detection unit.

17. The reception control circuit as claimed in claim 16, wherein the change detection unit includes a difference operation unit for obtaining a difference between an error detected at this time and an error detected at a last time; and a storage unit for storing the error detected at this time as the error detected at the last time after the difference operation unit has performed an operation.

18. The reception control circuit as claimed in claim 17, wherein the control signal detection unit does not change the amplification degree when the error detection unit detects that there in no errors.

19. The reception control circuit as claimed in claim 17, wherein the control signal output unit includes a positive/negative judgment unit for judging positiveness and negativeness of the difference obtained by the difference operation unit when the discrimination unit has discriminated that there is a change of the error; an amplification degree control unit for performing control of the amplification degree based on a judgment result of the positiveness and negativeness judgment unit and a state of the control signal outputted at the last detection of the change.

20. The reception control circuit as claimed in claim 19, wherein the amplification degree control unit raises the amplification degree when the difference obtained by the difference operation unit is positive and the control signal outputted in detection of the change at the last time is in a state of permitting a rising control, and when the difference obtained by the difference operation unit is negative and the control signal outputted in detection of the change at the last time is in a state of permitting a lowering control, and lowers the amplification degree when the difference obtained by the difference operation unit is negative and the control signal outputted in detection of the change at the last time is in the state of permitting the rising control, and when the difference obtained by the difference operation unit is positive and the control signal outputted in detection of the change at the last time is in the state of permitting lowering control.

21. The reception control circuit as claimed in claim 19, wherein the amplification degree control unit makes the control signal in a state of performing the rising control when the amplification degree has been raised, and makes the control signal in a state of performing the lowering control when the amplification degree has been lowered.

22. The reception control circuit as claimed in claim 16, wherein the reception grade detection unit detects an average value of power ratios of noises of a predetermined number of received SP signals and the reference SP signal to carrier power as an error.

23. A reception control method, comprising:
a reception grade detection step of detecting a reception grade of a received signal received by a tuner unit including an amplification unit;
a reference level detection step of detecting whether the detected reception grade satisfies a predetermined reference level or not;
a change detection step of detecting a change of the reception grade detected at the reception grade detection step only when the reception grade is detected not to satisfy the reference level; and
a control signal output step of outputting a control signal for controlling an amplification degree of an amplification unit of the tuner unit to raise or lower the amplification degree based on the change of the detected reception grade.

24. A reception control method, comprising:
a reception grade detection step of detecting a reception grade of a received signal received by a tuner unit including a plurality of amplification units;
a reference level detection unit of detecting whether the detected reception grade satisfies a predetermined reference level or not;
an amplification degree change step of changing at least one of amplification degrees of the plurality of amplification units only when the reception grade does not satisfy the reference level;
a change detection step of detecting a change of the detected reception grade based on a change of the amplification degree; and
a control signal output step of outputting a control signal for controlling an amplification degree of each of the plurality of amplification units of the tuner unit based on the detected change of the reception grade.

25. A reception control method, comprising:
a reception grade detection step of detecting an error of phases and amplitudes owned by SP signals arranged in a received signal in a way of being dispersed therein, the received signal received by a tuner unit including an amplification unit, from phases and amplitudes having been previously determined, the previously determined phases and the previously determined amplitudes owned by a reference SP signal, as a reception grade;
an error detection step of detecting whether the detected error is zero or not;
a change detection step of detecting a change of the detected reception grade only when the error is detected not to be zero; and
a control signal output step of outputting a control signal for controlling an amplification degree of the amplification unit of the tuner unit to raise or lower the amplification degree based on the change of the detected reception grade.
